(19) United States
(12) Patent Application Publication
(10) Pub. No.: US 2024/0152569 A1
(43) Pub. Date: May 9, 2024

(54) FINDING AND PRESENTING CONTENT RELEVANT TO A USER OBJECTIVE

(71) Applicant: International Business Machines Corporation, Armonk, NY (US)

(72) Inventors: Sri Harsha Varada, Vizianagaram (IN); Saraswathi Sailaja Perumalla, Visakhapatnam (IN); Pavan Kumar Penugonda, Anakapalle (IN); Tadas Dilba, Billerica, MA (US)

(21) Appl. No.: 17/982,146

(22) Filed: Nov. 7, 2022

(51) Int. Cl. G06F 16/957; G06F 16/34

(52) U.S. Cl. CPC G06F 16/9577; G06F 16/345

(57) ABSTRACT

A system for finding and presenting content relevant to a user objective includes a research management module configured to receive a research objective from a user and determine one or more sources of content visited by the user, a content evaluation module configured to determine whether the one or more sources of content visited by the user are relevant to the research objective and identify relevant sections of content within the sources of content visited by the user to produce identified sections of relevant content and a user interface module configured to present the identified sections of relevant content to the user. A computer-implemented method and computer program product corresponding to the above system are also disclosed herein.

### BACKGROUND

The subject matter disclosed herein relates generally to finding and presenting content and, in particular to, curating and presenting content relevant to a user objective.

Currently available search tools typically require users to wade through many sources of content to find information that is relevant. Once relevant material is found, users are required to organize and analyze the relevant material to determine whether the content provides new information or is simply accumulative. The time and effort required for such a process is often burdensome—particular for audio and video content.

### SUMMARY OF THE INVENTION

A computer-implemented method for finding and presenting content relevant to a user objective includes, receiving a research objective from a user, determining one or more sources of content visited by the user that are relevant to the research objective to produce relevant sources of content. The method may also include identifying relevant sections of content within the relevant sources of content to produce identified sections of content and presenting the identified sections of content to the user. A computer program product corresponding to the above method is also disclosed herein.

A system corresponding to the above method includes a research management module configured to receive a research objective from a user and determine one or more sources of content visited by the user, a content evaluation module configured to determine whether the one or more sources of content visited by the user are relevant to the research objective and identify relevant sections of content within the sources of content visited by the user to produce identified sections of relevant content and a user interface module configured to present the identified sections of relevant content to the user.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a block diagram of one example of a computing environment where the present invention may be deployed;

FIG. 2 is a flowchart of one example of a method for finding and presenting relevant content in accordance with at least one embodiment disclosed herein;

FIG. 3 is a block diagram of one example of a user interface in accordance with at least one embodiment disclosed herein;

FIGS. 4A and 4B are illustrations of various examples of content annotations and markings in accordance with at least one embodiment disclosed herein;

FIG. 5A is a block diagram illustrating various portions of a computing environment in accordance with at least one embodiment disclosed herein; and

FIG. 5B is a block diagram illustrating one example of a computing stack in accordance with at least one embodiment disclosed herein.

### DETAILED DESCRIPTION OF THE INVENTION

One of ordinary skill in the art will appreciate that references throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

One of skill in the art will appreciate that users are often required to wade through many different information sources to find content that is meaningful to their objectives. Furthermore, users may be required to revisit and compare those sources to determine which sources are most relevant and then do one or more activities to make use of the content such as extract, summarize and annotate the relevant content. Such a process can be very time consuming and tedious. The technology and solutions disclosed herein address one or more of the above issues.

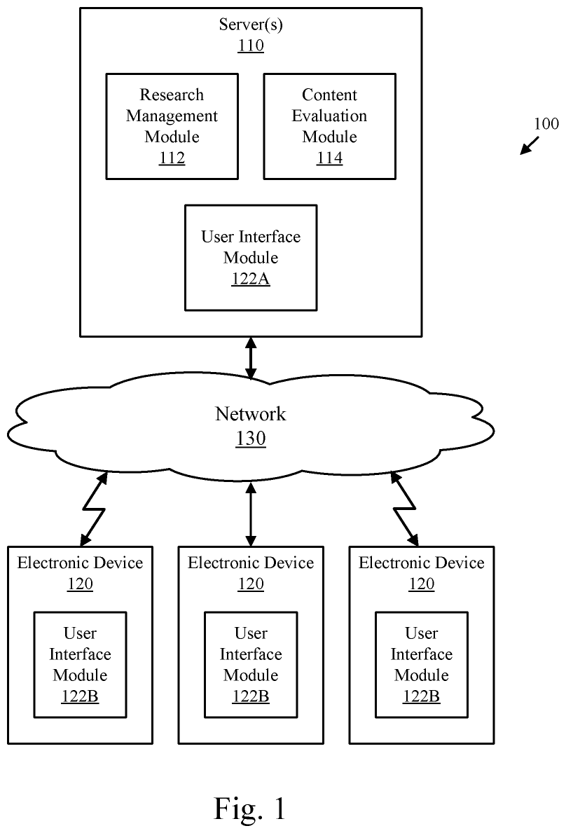

FIG. 1 is a block diagram of one example of a computing environment 100 wherein the present invention may be deployed. As depicted, the computing environment 100 includes one or more servers 110 and various electronic devices 120 interconnected via one or more networks 130. The computing environment 100 enables users of the electronic devices 120 to access computing services provided by the servers 110.

The electronic devices 120 may have various applications installed thereon (not shown) that enable users of those devices to leverage computing services (not shown) provided by the servers 110. For example, the servers 110 may be cloud servers that provide a wide variety of scalable services to enterprise users. The depicted servers 110 may provide content search and presentation services via one or more research management modules 112, content evaluation modules 114 and user interface modules 122.

The research management modules 112 and content evaluation modules 114 may function cooperatively to enable users of the electronic devices 120 to find content relevant to a user specified objective. The relevant content may be presented to, and reviewed by, the users via the user interface modules 122.

Depending on the computing environment, the depicted modules 112, 114 and 122 may reside partially or wholly on the servers 110 or the electronic devices (clients) 120. In the depicted embodiment, the user interface modules 122 are partitioned into a server portion 122A and a client portion 122B. In another embodiment, the user interface modules 122 reside wholly on the electronic devices 120.

The research management module 112 may receive a request to find content relevant to a user objective from an application or utility executed by a user of an electronic device 120. In response thereto, the research management module 112 may determine one or more sources of content visited by the user (e.g., via a web browser) and request that the content evaluation module 114 determine if the one or more sources of content visited by the user are relevant to the user objective. The content evaluation module 114 may also identify relevant sections of content within the sources of content visited by the user, create content summaries and mark the identified sections with markings that help the user evaluate and understand the identified sections of relevant content. The user interface modules 122 may present the identified sections of relevant content along with content summaries and markings to the user.

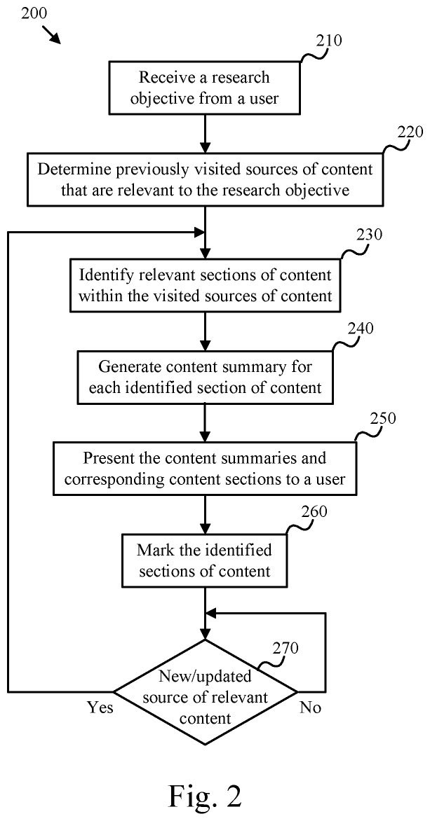

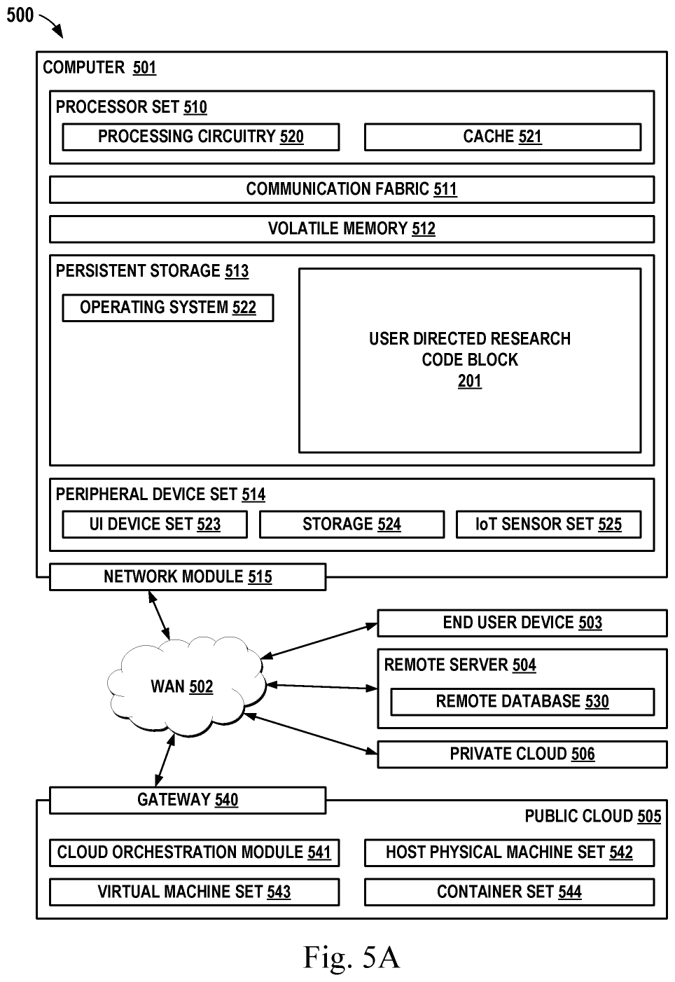

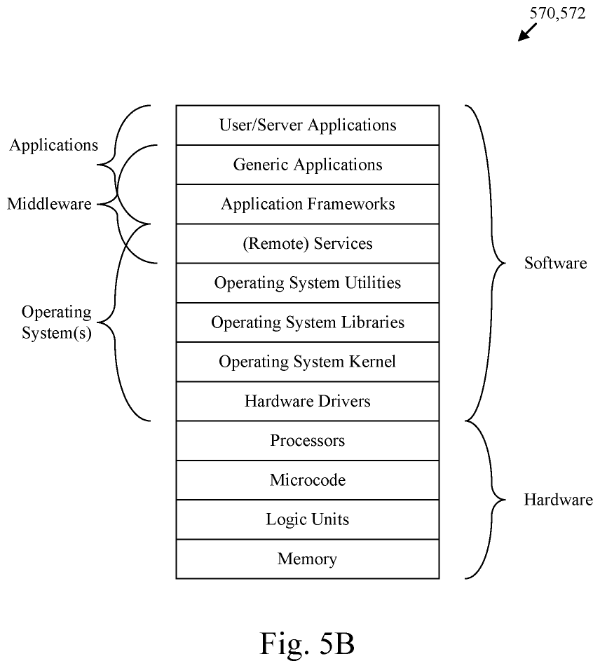

FIG. 2 is a flowchart of one example of a method 200 for finding and presenting relevant content in accordance with at least one embodiment disclosed herein. As depicted, the method 200 includes receiving (210) a research objective from a user, determining (220) one or more sources of relevant content, identifying (230) relevant sections of content, generating (240) content summaries, presenting (250) the content summaries and corresponding sections of content to the user, marking (260) the identified sections of content, and determining (270) whether a new or updated source of relevant content exists. The method 200 enables users to review and understand content relevant to a specified objective. The method 200 may be embodied as the user directed research code block 201 shown in FIG. 5A.

Receiving (210) a research objective from a user may include presenting a interface to the user that enables the user to specify a research objective. In some implementations, the user interface prompts the user for an intended action and subject which collectively define the research objective. For example, a user may specify ‘fix’ as an intended action and ‘kitchen faucet’ as the subject. The user interface may also prompt the user for an optional target completion date for the objective.

Determining (220) one or more sources of relevant content may include determining sources of content visited by the user that are relevant to the research objective. In some implementations, a user's browsing history is reviewed to determine if any sources of content have been visited. For example, the user's browsing history may indicate that one or more articles and videos have been viewed in response to a web search for “repair leaky kitchen faucet.”

Identifying (230) relevant sections of content within the relevant sources of content may include processing the relevant sources of content to determine sections within the source of content that are relevant to the user's objective. In one implementation, a semantic vector is generated for each sentence and compared to the user objective for relevance. Generating (240) content summaries may include using natural language processing tools to determine keywords and concepts that are communicated by the relevant sections of content.

Presenting (250) the content summaries and corresponding sections of content to the user may include displaying the identifies sections of content and overlaying or annotating the content with the generated summaries. In some implementations, a summary matrix that displays summaries from all the relevant sources of content may be assembled and displayed to the user.

Marking (260) the identified sections of content may include marking or annotating the sections of content as to whether the content comprises new information, old information, a differing perspective, a concurring perspective, or the like. The markings may be color and/or pattern coded to visually (i.e., efficiently) communicate the type of marking. With media files such as video, time codes may be associated with the markings. Determining the appropriate type of marking that can be appropriately applied to a relevant section of content may be accomplished by generating a semantic vector and/or conducting sentiment analysis for each identified section of content and using the semantic vectors and/or sentiment analysis to determine appropriate markings.

Determining (270) whether a new or updated source of relevant content exists may include monitoring user web searches, browsing and document viewing activities and assessing if the visited content is relevant to the user objective. Determining (270) whether a new or updated source of relevant content exists may also include visiting existing sources of content and determining whether the content has been updated. In some implementations, new sources of content are automatically found by using the research objective and/or the content summaries from the existing sources of content to initiate a new search for relevant content. When a new or updated source of relevant content is found, the method 200 may loop to the identifying operation 230.

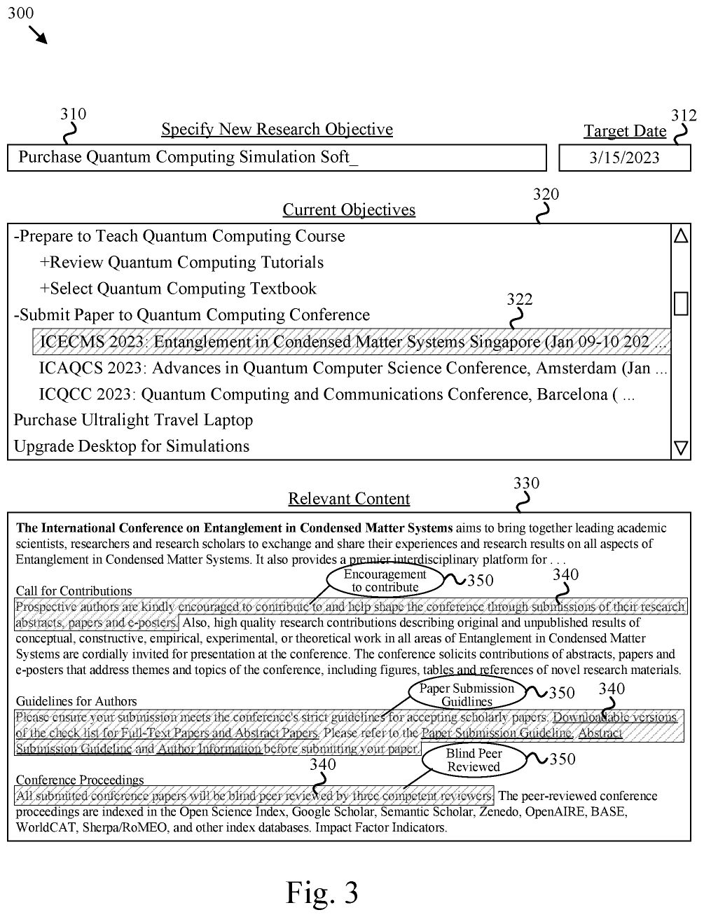

FIG. 3 is a block diagram of one example of a user interface 300 in accordance with at least one embodiment disclosed herein. As depicted, the user interface 300 includes an objective entry field 310, a current objectives list 320, and a relevant content panel 330. The user interface 300 enables a user to specify and review user objectives as well as content that is relevant to the user objectives.

The objective entry field 310 enables a user to specify a new user (i.e., research) objective. In the depicted example, the user objective may be specified via natural language. In another example, an action field and a subject field are used to specify the user objective. A target date field 312 may be used to specify a desired completion date for the user objective.

The current objectives list 320 lists the currently active user objectives and the sources of content that have been found for each of those objectives. In the depicted example, the list 320 is a hierarchical list that enables the user to indicate that some user objectives are sub-objectives. For example, selecting an objective and using interface controls such as tab and control-tab my demote or promote a selected objective in the hierarchy. Portions of the list may also be expanded or collapsed via user interface controls (e.g., clicking on an element of the list).

The depicted current objectives list 320 also indicates the sources of content that are relevant to the user objective by listing a reference to, or title for, each of the sources as children of the corresponding objective in the hierarchical list. A selected content source 322 may be specified by selecting a content source reference or title. For example, clicking on a content source title displayed in the current objectives list 320 may select the content source, highlight the selection and display content from the selected content source in the relevant content panel 330.

The relevant content panel 330 displays content from the selected content source 322. The displayed content may include text, images, videos, audio, tables, charts and the like. In some cases, only the relevant sections of content 340 and (optionally) immediately adjacent content is displayed. In those cases, other sections of content from the displayed source may be omitted or collapsed. The content displayed in the relevant content panel 330 may be augmented with annotations 350 such as content summaries and markings. The depicted annotations 350 are brief summaries of the relevant sections of content 340.

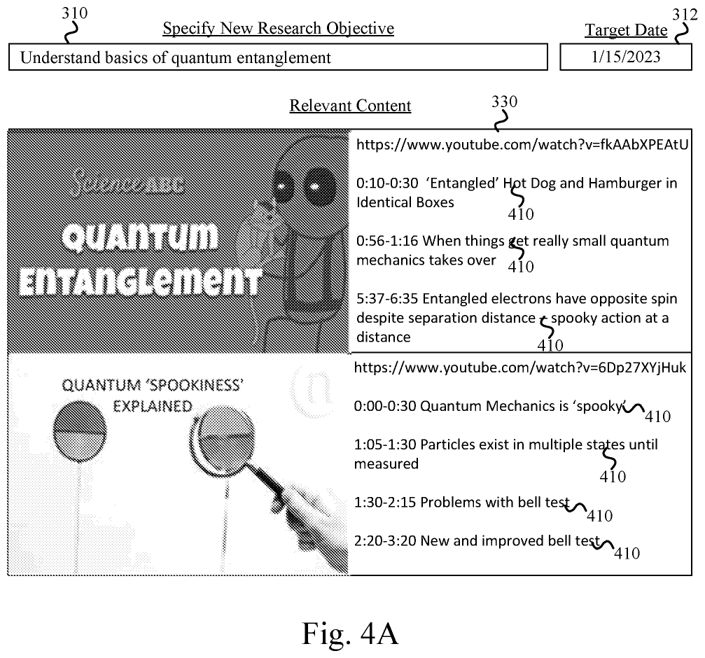

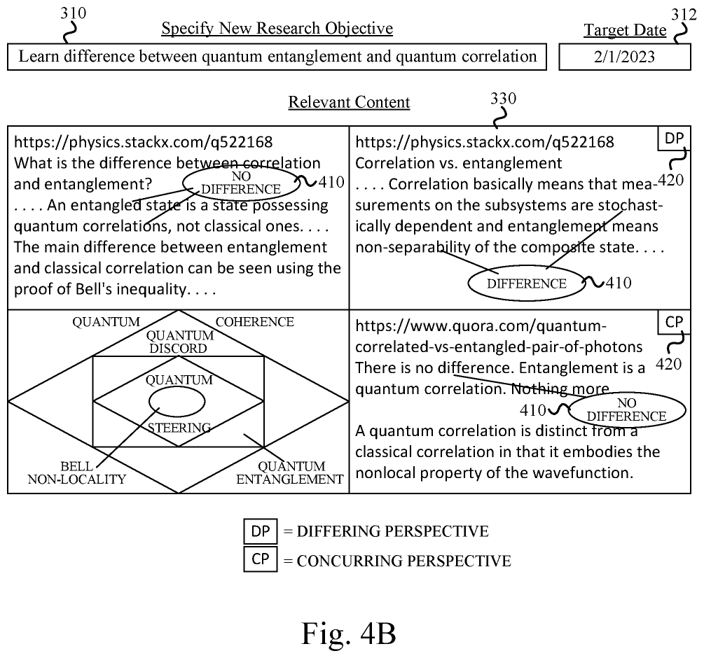

FIGS. 4A and 4B are illustrations of various examples of content annotations 410 and markings 420 in accordance with at least one embodiment disclosed herein. In FIG. 4A, the annotations 410 are content summaries that also indicate the start and end times of an identified section of content. In FIG. 4B, the annotations 410 indicate whether the identified section of content indicates whether the identified section of content specifies that there is a difference or that there is no difference between quantum entanglement and quantum correlation. The markings 420 shown in FIG. 4B indicate whether an identified section of content has a differing perspective [DP] or a concurring perspective [CP] relative to the section of content shown in the upper-left quadrant of the relevant content panel 330. The annotations 410 and markings 420 shown in FIGS. 4A and 4B help the user achieve the objective specified in the objective entry field 310.

One of skill in the art will appreciate the utility and effectiveness of the solutions disclosed herein. For example, assume that is user intends to purchase a laptop. The user may specify an objective such as “purchase laptop” using the objective entry field 310. The user's browsing history may be examined to find references to content relevant to the objective. When the user visits a new site to view a video reviewing a particular laptop, natural language processing may be used to mark relevant segments in the new video as well as previously viewed videos/content. The segments may be annotated to inform the user as to the topic of the segments and whether the segment includes unique or contradicting content.

As disclosed herein, a computer-implemented method for finding and presenting content relevant to a user objective may include:
receiving a research objective from a user
determining one or more sources of content visited by the user that are relevant to the research objective to produce relevant sources of content
identifying relevant sections of content within the relevant sources of content to produce identified sections of content
presenting the identified sections of content to the user

Additional features for the above method may include:
wherein determining one or more sources of content visited by the user comprises monitoring web searches
wherein determining one or more sources of content visited by the user comprises monitoring documents viewed by the user
wherein determining one or more sources of content visited by the user comprises examining a browsing history
wherein the research objective comprises an intended action and subject
generating a summary for each identified section of content to produce content summaries for the identified sections of content
marking the identified sections of content with one or more markings
   wherein the one or more markings include one or more of a new information marking, an old information marking, a differing perspective marking, and a concurring perspective marking
   wherein marking comprises highlighting or annotating an identified section
determining additional relevant sections of content within a new source of content in response to the user visiting the new source of content
   generating additional content summaries for the additional relevant sections of content
      presenting the additional content summaries to the user

As disclosed herein, a system for finding and presenting content relevant to a user objective may include:
a research management module configured to
   receive a research objective from a user
   determine one or more sources of content visited by the user
a content evaluation module configured to
   determine if the one or more sources of content visited by the user are relevant to the research objective
   identify relevant sections of content within the sources of content visited by the user to produce identified sections of relevant content
a user interface module configured to present the identified sections of relevant content to the user

Additional features for the above method may include:
wherein the content evaluation module is configured to determine one or more sources of content visited by the user by monitoring web searches
wherein the content evaluation module is configured to determine one or more sources of content visited by the user by examining a browsing history
wherein the research objective comprises an intended action and subject
the content evaluation module further configured to
   generate a summary for each identified section of relevant content to produce content summaries for the identified sections of relevant content
   determine additional relevant sections of content within a new source of content responsive to the user visiting the new source of content
      generate additional content summaries for additional relevant sections of content
the user interface module configured to mark the identified sections of content with one or more markings
   wherein the one or more markings include one or more of a new information marking, an old information marking, a differing perspective marking, and a concurring perspective marking
   wherein marking comprises highlighting or annotating an identified section
the user interface module configured to present additional content summaries to the user

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 5A is a block diagram illustrating various portions of a computing environment 500 in accordance with at least one embodiment disclosed herein. Computing environment 500 contains an example of an environment for the execution of at least some of the computer code involved in performing the inventive methods, such as user directed research code block 201 (corresponding to the method 200 shown in FIG. 2). In some embodiments, portions of code block 201 reside within the operating system 522. In addition to block 201, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 201, as identified above), peripheral device set 514 (including user interface (UI) device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5A. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in block 201 in persistent storage 513.

COMMUNICATION FABRIC 511 is the signal conduction path that allows the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, volatile memory 512 is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface-type operating systems that employ a kernel. The code included in block 201 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

FIG. 5B is a block diagram illustrating one example of a computing stack 570 in accordance with at least one embodiment disclosed herein. As depicted, the computing stack 570 includes a number of computing layers 572 used for conducting computing operations. In the depicted embodiment, the layers include hardware layers and software layers. The various software layers include operating system layers associated with executing one or more operating systems, middleware layers associated with executing middleware that expands and/or improves the functionality of hardware layers, and executing operating system(s). The software layers may also include various application-specific layers. The application-specific layers may include application frameworks that further expand on, and/or improve upon, the functionality of hardware layers and operating system layers.

The memory layer may include volatile memory, non-volatile memory, persistent storage and hardware associated with controlling such memory. The logic units may include CPUs, arithmetic units, graphic processing units, and hardware associated with controlling such units. The microcode layer may include executable instructions for controlling the processing flow associated with moving data between memory and the logic units. The processor layer may include instruction fetch units, instruction decode units, and the like that enable execution of processing instructions and utilization of the underlying hardware layers.

The hardware drivers (also known as the hardware abstraction layer) may include executable code that enables an operating system to access and control storage devices, DMA hardware, I/O buses, peripheral devices, and other hardware associated with a computing environment. The operating system kernel layer may receive I/O requests from higher layers and manage memory and other hardware resources via the hardware drivers. The operating system kernel layer may also provide other functions such as inter-process communication and file management.

Operating system libraries and utilities may expand the functionality provided by the operating system kernel and provide an interface for accessing those functions. Libraries are typically leveraged by higher layers of software by linking library object code into higher level software executables. In contrast, operating system utilities are typically standalone executables that can be invoked via an operating system shell that receives commands from a user and/or a script file. Examples of operating system libraries include file I/O libraries, math libraries, memory management libraries, process control libraries, data access libraries, and the like. Examples of operating system utilities include anti-virus managers, disk formatters, disk defragmenters, file compressors, data or file sorters, data archivers, memory testers, program installers, package managers, network utilities, system monitors, system profilers, and the like.

Services are often provided by a running executable or process that receives local or remote requests from other processes or devices called clients. A computer running a service is often referred to as a server. Examples of servers include database servers, file servers, mail servers, print servers, web servers, game servers, and application servers.

Application frameworks provide functionality that is commonly needed by applications and include system infrastructure frameworks, middleware integration, frameworks, enterprise application frameworks, graphical rendering frameworks, and gaming frameworks. An application framework may support application development for a specific environment or industry. In some cases, application frameworks are available for multiple operating systems and providing a common programming interface to developers across multiple platforms.

Generic applications include applications that are needed by most users. Examples of generic applications include mail applications, calendaring and scheduling applications, and web browsers. Such applications may be automatically included with an operating system.

One of skill in the art will appreciate that an improvement to any of the depicted layers, or similar layers that are not depicted herein, results in an improvement to the computer itself including the computer 501 and/or the end user devices 503. One of skill in the art will also appreciate that the depicted layers are given by way of example are not representative of all computing devices. Nevertheless, the concept of improving the computer itself by improving one or more functional layers is essentially universal.

The executables and programs described herein are identified based upon the application or software layer for which they are implemented in a specific embodiment of the present invention. However, it should be appreciated that any particular program nomenclature herein is used merely for convenience, and thus the present invention should not be limited to use solely in any specific identified application or software layer.

The features, advantages, and characteristics of the embodiments described herein may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

Some of the functional units described in this specification may have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

In the preceding description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

The description of elements in each figure may refer to elements of proceeding figures. Like numbers refer to like elements in all figures, including alternate embodiments of like elements. The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer-implemented method, comprising:
receiving, via a user interface, a subject and an intended action related to the subject defining a research objective from a user;
prompting, via the user interface, the user for a completion date associated with the research objective;
in response to receiving the research objective, determining one or more sources of content in a network visited by the user that are relevant to the research objective to produce relevant sources of content;
identifying relevant sections of content within the relevant sources of content to produce identified sections of content, wherein the relevant sections of content are identified by comparing semantic vectors for content within each of the one or more sources of content and the research objective to determine a match; and
in response to determining a match, presenting each identified relevant section of content to the user.

2. The method of claim 1, wherein determining one or more sources of content visited by the user comprises monitoring documents viewed by the user, or monitoring web searches.

3. The method of claim 1, wherein determining one or more sources of content visited by the user comprises examining a browsing history.

4. (canceled)

5. The method of claim 1, further comprising generating a summary for an identified section of content to produce a content summary for the identified section of content.

6. The method of claim 1, further comprising marking an identified section of content with one or more markings.

7. The method of claim 6, wherein the one or more markings include one or more of a new information marking, an old information marking, a differing perspective marking, and a concurring perspective marking.

8. The method of claim 1, further comprising determining additional relevant sections of content within a new source of content in response to the user visiting the new source of content.

9. The method of claim 8, further comprising generating additional content summaries for the additional relevant sections of content.

10. The method of claim 9, further comprising presenting the additional content summaries to the user.

11. A computer program product comprising a computer-readable storage medium having program instructions embodied therewith, wherein the computer-readable storage medium is not a transitory signal per se, the program instructions executable by a processor to cause the processor to conduct a method comprising:
receiving, via a user interface, a subject and an intended action related to the subject defining a research objective from a user;
prompting, via the user interface, the user for a completion date associated with the research objective;
in response to receiving the research objective, determining one or more sources of content in a network visited by the user that are relevant to the research objective to produce relevant sources of content;
identifying relevant sections of content within the relevant sources of content to produce identified sections of content, wherein the relevant sections of content are identified by comparing semantic vectors for content within each of the one or more sources of content and the research objective to determine a match; and
in response to determining a match, presenting each identified relevant section of content to the user.

12. A system, comprising:
a research management module configured to:
receive a research objective from a user, and
prompt the user for a completion date associated with the research objective, and
determine one or more sources of content in a network visited by the user;
a content evaluation module configured to, in response to receiving the research objective:
determine whether the one or more sources of content visited by the user are relevant to the research objective, and
identify relevant sections of content within the sources of content visited by the user to produce identified sections of relevant content, wherein the relevant sections of content are identified by comparing semantic vectors for the content within each of the one or more sources of content and the research objective to determine a match; and
a user interface module configured to, in response to a match, present each identified section of relevant content to the user,
wherein at least a portion of each of said modules comprises one or more of a set of hardware circuits, a set of programmable hardware devices, and executable code stored on a set of non-transitory computer-readable storage media.

13. The system of claim 12, wherein the content evaluation module is configured to determine one or more sources of content visited by the user by conducting one or more of monitoring viewed documents, monitoring web searches, and examining a browsing history.

14. (canceled)

15. The system of claim 12, wherein the content evaluation module is further configured to generate a summary for an identified section of relevant content to produce a content summary for the identified section of relevant content.

16. The system of claim 12, wherein the content evaluation module is further configured to determine additional relevant sections of content within a new source of content responsive to the user visiting the new source of content.

17. The system of claim 16, wherein the content evaluation module is further configured to generate additional content summaries for the additional relevant sections of content.

18. The system of claim 17, wherein the user interface module is configured to present the additional content summaries to the user

19. The system of claim 12, wherein the user interface module is configured to mark the identified sections of content with one or more markings.

20. The system of claim 19, wherein the one or more markings include one or more of a new information marking, an old information marking, a differing perspective marking, and a concurring perspective marking.

21. The method of claim 6, wherein marking the identified section of content with one or more markings comprises:
performing at least one of generating a semantic vector and conducting a sentiment analysis for each identified section of content; and
using the at least one of the generated semantic vector and the conducted sentiment analysis to determine a type of marking for the one or more markings.

22. The system of claim 19, wherein, in marking the identified section of content with one or more markings, the user interface module is configured to:
perform at least one of generate a semantic vector and conduct a sentiment analysis for each identified section of content; and
use the at least one of the generated semantic vector and the conducted sentiment analysis to determine a type of marking for the one or more markings.
